(19) United States
(12) Patent Application Publication
(10) Pub. No.: US 2010/0245341 A1
(43) Pub. Date: Sep. 30, 2010

(54) DISPLAY DEVICE HAVING NON-VOLATILE DISPLAY UNIT DRIVEN WITH POWER SUPPLIED FROM BATTERY

(75) Inventor: Nobuyuki Tanaka, Iwakura-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/713,367

(22) Filed: Feb. 26, 2010

(30) Foreign Application Priority Data
Mar. 30, 2009 (JP) 2009-082210

(51) Int. Cl. G09G 5/00

(52) U.S. Cl. 345/214

(57) ABSTRACT

A display device includes: a nonvolatile display unit; a battery holding unit; an input unit; a determining unit; and a rewrite control unit. The nonvolatile display unit is configured so as to be capable of displaying an image and maintaining the displayed image even when the nonvolatile display unit is supplied with no electric power. The battery holding unit is configured so as to be holding a battery, the battery held in the battery holding unit being capable of supplying electric power to the nonvolatile display unit. The input unit is configured so as to be capable of receiving an image rewrite instruction to perform an image rewriting operation to change an image currently displayed in the nonvolatile display unit. The determining unit is configured so as to be capable of determining an amount of power that remains in the battery held in the battery holding unit. In response to the image rewrite instruction, the rewrite control unit controls the nonvolatile display unit to perform an image rewriting operation to change the currently-displayed image if the amount of power that remains in the battery is greater than or equal to a threshold value and controls the nonvolatile display unit not to perform the image rewriting operation if the amount of power that remains in the battery is smaller than the threshold value.

### CROSS REFERENCE TO RELATED APPLICATION

This application claims priority from Japanese Patent Application No. 2009-082210 filed Mar. 30, 2009. The entire content of the priority application is incorporated herein by reference.

### TECHNICAL FIELD

The present invention relates to a display device.

### BACKGROUND

There has been known a display device having a nonvolatile display unit, such as an electrophoretic display or a cholesteric liquid crystal display. In this type of display device, an image remains displayed even after a power supply is cut off.

### SUMMARY

A battery may be mounted in the display device to supply power to the nonvolatile display unit. While the display device is executing an image rewriting operation to change an image currently displayed on the nonvolatile display into another one, the power supply to the nonvolatile display unit will possibly be cut off due to a shortage of the power remaining in the battery. In such a case, the image rewriting operation is stopped in the middle thereof, and an incompletely-rewritten image will be displayed on the nonvolatile display unit. In order to recover the shortage of the power remaining in the battery, the battery needs to be exchanged to a new one or needs to be recharged. The incompletely-changed image will remain displayed in the display device until the shortage of the power in the battery is recovered and the display device performs the image rewriting operation again.

In view of the foregoing, it is an object of the present invention to provide an improved display device that will not display an incompletely-rewritten image.

In order to attain the above and other objects, the present invention provides a display device including: a nonvolatile display unit; a battery holding unit; an input unit; a determining unit; and a rewrite control unit. The nonvolatile display unit is configured so as to be capable of displaying an image and maintaining the displayed image even when the nonvolatile display unit is supplied with no electric power. The battery holding unit is configured so as to be holding a battery, the battery held in the battery holding unit being capable of supplying electric power to the nonvolatile display unit. The input unit is configured so as to be capable of receiving an image rewrite instruction to perform an image rewriting operation to change an image currently displayed in the nonvolatile display unit. The determining unit is configured so as to be capable of determining an amount of power that remains in the battery held in the battery holding unit. In response to the image rewrite instruction, the rewrite control unit controls the nonvolatile display unit to perform an image rewriting operation to change the currently-displayed image if the amount of power that remains in the battery is greater than or equal to a threshold value and controls the nonvolatile display unit not to perform the image rewriting operation if the amount of power that remains in the battery is smaller than the threshold value.

According to another aspect, the present invention provides a method of controlling a nonvolatile display unit by using electric power supplied from a battery, the nonvolatile display unit being configured so as to be capable of displaying an image and maintaining the displayed image even when the nonvolatile display unit is supplied with no electric power, the method including: receiving an image rewrite instruction to perform an image rewriting operation to change an image currently displayed in the nonvolatile display unit; determining an amount of power that remains in the battery; and controlling, in response to the image rewrite instruction, the nonvolatile display unit to perform an image rewriting operation to change the currently-displayed image if the amount of power that remains in the battery is greater than or equal to a threshold value and controlling the nonvolatile display unit not to perform the image rewriting operation if the amount of power that remains in the battery is smaller than the threshold value.

According to another aspect, the present invention provides a computer readable storage medium storing a set of program instructions for controlling a nonvolatile display unit by using electric power supplied from a battery, the nonvolatile display unit being configured so as to be capable of displaying an image and maintaining the displayed image even when the nonvolatile display unit is supplied with no electric power, the instructions including: receiving an image rewrite instruction to perform an image rewriting operation to change an image currently displayed in the nonvolatile display unit; determining an amount of power that remains in the battery; and controlling, in response to the image rewriting instruction, the nonvolatile display unit to perform an image rewriting operation to change the currently-displayed image if the amount of power that remains in the battery is greater than or equal to a threshold value and controlling the nonvolatile display unit not to perform the image rewriting operation if the amount of power that remains in the battery is smaller than the threshold value.

### BRIEF DESCRIPTION OF THE DRAWINGS

The particular features and advantages of the invention as well as other objects will become apparent from the following description taken in connection with the accompanying drawings, in which:

FIG. 1 is a schematic view showing an external appearance of a display device according to an embodiment of the present invention;

FIG. 2 is a block diagram showing a hardware structure of the display device;

FIG. 3 is a flowchart illustrating steps in a main process executed by the display device;

FIGS. 4A-4C are schematic views showing exemplary images of several pages included in an image file displayed in a nonvolatile display panel of the display device, wherein FIG. 4A shows an exemplary image of a third page, FIG. 4B shows an exemplary image of a fourth page, and FIG. 4C shows an exemplary image of a notification image that is generated based on an image of a fifth page;

FIG. 5 is a flowchart illustrating steps in a rewrite process in the main process of FIG. 3; and

FIG. 6 is a flowchart illustrating steps in a rewrite process according to a modification.

### DETAILED DESCRIPTION

A display device according to an embodiment of the present invention will be described while referring to the accompanying drawings.

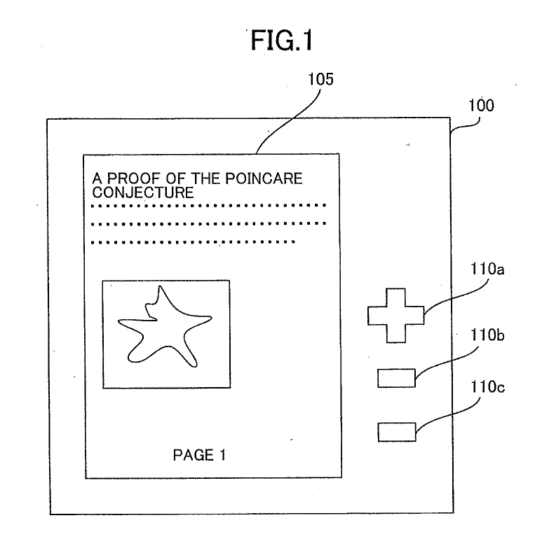

As shown in FIG. 1, a display device 100 according to the embodiment has a nonvolatile display panel 105, a cross-shaped button 110a, a cancel button 110b, and a determination button 110c. The nonvolatile display panel 105 is of an electrophoretic type. The nonvolatile display panel 105 is for displaying images. The cross-shaped button 110a, cancel button 110b, and determination button 110c serve as operation buttons. The user can input his/her instructions to the display device 100 by operating the cross-shaped button 110a, cancel button 110b, and determination button 110c.

The nonvolatile display panel 105 can display various types of images according to the user's instructions that are inputted to the display device 100 in response to the user's operation of the operation buttons 110a, 110b, and 110c. Images displayed in the nonvolatile display panel 105 include: an image included in an image file in a predetermined format capable of being displayed in the display device 100; an image of a selection screen for urging the user to select an image file to be displayed in the display device 100; and a menu image for urging the user to select a menu item desired to be executed by the display device 100.

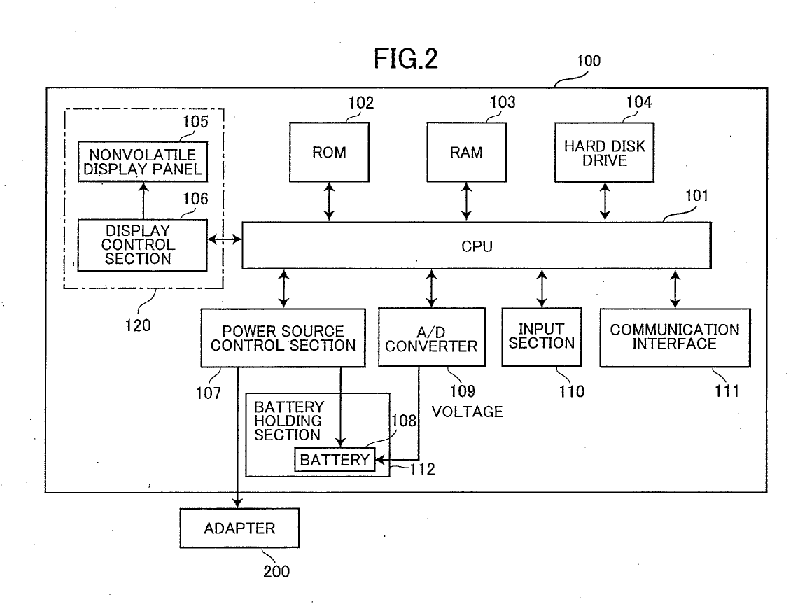

Next, the hardware structure of the display device 100 will be described while referring to FIG. 2.

As shown in FIG. 2, the display device 100 includes: a CPU 101, a ROM 102, a RAM 103, a hard disk drive 104, a nonvolatile display section 120, a power source control section 107, a battery holding section 112, an A/D converter 109, an input section 110, and a communication interface 111. An adapter 200 is connected to the power source control section 107. A battery 108 can be detachably mounted in the battery holding section 112.

The nonvolatile display section 120 includes the nonvolatile display panel 105 shown in FIG. 1 and a display control section 106.

The ROM 102, RAM 103, hard disk drive 104, display control section 106, power source control section 107, battery holding section 112, A/D converter 109, input section 110, and communication interface 111 are connected to the CPU 101.

The CPU 101, the ROM 102, and the RAM 103 serve as a computer and cooperate with one another to perform respective processes to be described later.

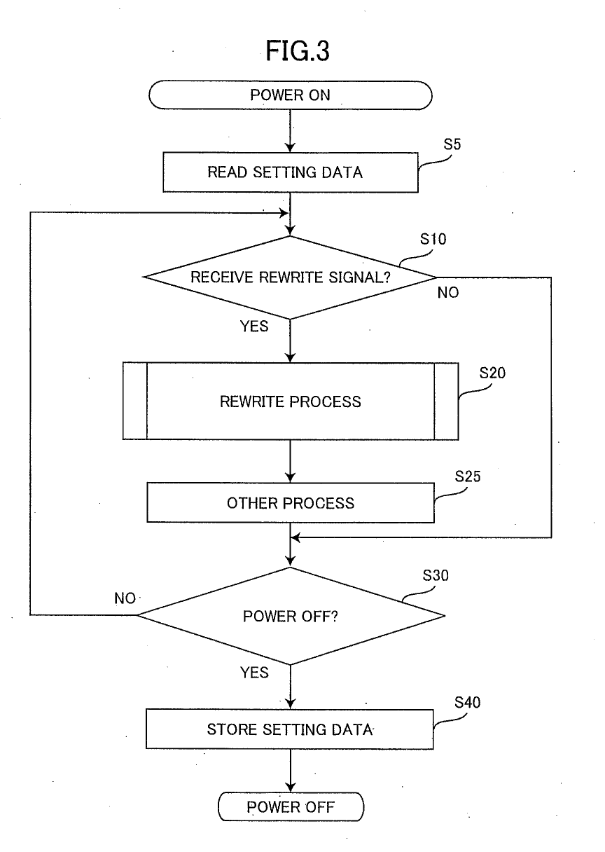

The CPU 101 is for controlling the entire display device 100 in accordance with a program stored in the ROM 102. The ROM 102 is a nonvolatile storage device and stores therein a program for a main process, a predetermined message, and predetermined threshold values A, B, C, and D to be described later. The main process will be described later with reference to FIGS. 3-5. The message has previously been set for the program of the main process to indicate that “battery level is low,” in this example. The RAM 103 is a volatile storage device for temporarily storing the program read out from the ROM 102 and other data necessary for the CPU 101 to execute the program and various processes. For example, the RAM 103 temporarily stores setting data, such as data indicative of a rewrite mode selected by the user (to be described later).

The input section 110 is for receiving the user's instruction. The input section 110 includes the cross-shaped button 110a, cancel button 110b, and determination button 110c shown in FIG. 1. When the user presses any of these buttons, the input section 110 outputs a signal indicative of the pressed button (in case of the cross-shaped button 110a, a signal indicative of the pressed direction of the cross-shaped button 110a) to the CPU 101. Based on the signal, the CPU 101 determines which of the buttons the user has pressed.

The communication interface 111 is for transmitting and receiving data of an image file in the predetermined format displayable in the display device 100 to/from an external device such as a personal computer. The image file can be generated by converting a document file or an image file, which has been generated by a well-known application program executed on a personal computer, into the predetermined format that is in conformity with the display device 100.

The hard disk drive 104 is for storing the image file in the predetermined format. The hard disk drive 104 receives the image file from the communication interface 111 and stores the same.

Although not shown in the drawings, the nonvolatile display panel 105 has a transparent substrate, a backside substrate, and an electrophretic display medium. The transparent substrate is disposed on a display surface of the nonvolatile display panel 105. The backside substrate is disposed opposite to the transparent substrate. The electrophoretic display medium is disposed between the transparent substrate and the backside substrate. The nonvolatile display panel 105 is of an active matrix type. The nonvolatile display panel 105 therefore has a plurality of pixel electrodes, a plurality of gate lines, and a plurality of source lines, which are provided on the backside substrate, for example.

The display control section 106 is for performing image rewriting operation on the nonvolatile display panel 105 to change an image that is currently being displayed in the nonvolatile display panel 105 into another image.

Although not shown in the drawing, the display control section 106 includes: a gate driver; a source driver; and a display controller. The gate driver is for outputting gate signals to the respective gate lines in the nonvolatile display panel 105. The source driver is for outputting source signals to the respective source lines in the nonvolatile display panel 105. The display controller is for controlling the gate driver to output the gate signals and controlling the source driver to output the source signals.

With this configuration, upon receipt of an image rewriting instruction from the CPU 101, the display control section 106 outputs gate signals to the gate lines and outputs source signals to the source lines. The gate signals and source signals apply the pixel electrodes in the nonvolatile display panel 105 with drive voltages, whereupon the electrophoretic display medium is activated to perform an image rewriting operation to change the currently-displayed image into another image. In this way, the image currently displayed in the nonvolatile display panel 105 is changed into another image.

The nonvolatile display panel 105 is capable of maintaining the displayed image without consuming electric power. Accordingly, the image displayed on the nonvolatile display panel 105 remains being displayed even when power supply to the nonvolatile display section 120 is cut off. In addition, the nonvolatile display panel 105 consumes less electric power, compared with a display panel of a self light-emitting type, such as a conventional LCD (liquid crystal display) panel and a PDP (plasma display panel) panel, which consumes electric power to maintain a displayed image.

As described above, the power source control section 107 is connected to the adapter 200. The power source control section 107 is connected also to the battery 108 when the battery 108 is mounted in the display device 100.

The adapter 200 is an AC-DC adapter for receiving AC power from a commercial power supply via an outlet, converting the AC power to DC power of a format in conformity with the display device 100, and supplying the DC power to the power source control section 107.

The battery 108 is a rechargeable battery, such as a lithium-ion rechargeable battery. The power source control section 107 receives electric power from the battery 108 when the adapter 200 is not connected to the outlet.

When the power source control section 107 receives electric power from the adapter 200, the power source control section 107 supplies the electric power to each unit in the display device 100 as well as outputs to the CPU 101a signal indicating that electric power is supplied from the adapter 200. When the power source control section 107 receives electric power from the battery 108, the power source control section 107 supplies the electric power to each unit in the display device 100 as well as outputs to the CPU 101a signal indicating that electric power is supplied from the battery 108.

When the power source control section 107 receives electric power from the adapter 200, the power source control section 107 supplies the electric power also to the battery 108 to charge the battery 108 if the battery 108 is mounted in the display device 100. The power source control section 107 supplies electric power to the nonvolatile display section 120 only when the display control section 106 executes an image rewriting operation onto the nonvolatile display panel 105. In other words, the power source control section 107 does not supply electric power to the nonvolatile display section 120 while the nonvolatile display panel 105 maintains the displayed image unchanged. This can reduce the amount of electric power consumed by the nonvolatile display section 120.

The A/D converter 109 is for measuring the voltage of the battery 108, converting an analogue signal indicative of the measured voltage to a digital signal, and outputting the digital signal to the CPU 101.

According to the present embodiment, the user can select, as a rewriting mode, either a normal mode or a power-saving mode by operating the input section 110. In the normal mode, the display control section 106 performs an image rewriting operation under normal consumption of electric power. In the power-saving mode, the display control section 106 performs an image rewriting operation while consuming an electric power of an amount less than in the normal mode. In this example, duration for applying the drive voltage is shorter in the power-saving mode than in the normal mode. Therefore, during the power-saving mode, the display device 100 can rewrite the displayed image with less electric power consumption than during the normal mode.

Next, the threshold values A to D stored in the ROM 102 will be described.

The threshold value A is equal to the value of the voltage of the battery 108 when power remains in the battery 108 with an amount necessary for performing an image rewriting operation two times in the normal mode. The threshold value B is equal to the value of the voltage of the battery 108 when power remains in the battery 108 with an amount necessary for performing an image rewriting operation one time in the normal mode. The threshold value C is equal to the value of the voltage of the battery 108 when power remains in the battery 108 with an amount necessary for performing an image rewriting operation two times in the power-saving mode. The threshold value D is equal to the value of the voltage of the battery 108 when power remains in the battery 108 with an amount necessary for performing an image rewriting operation one time in the power-saving mode. The threshold value A is greater than the threshold value B. The threshold value C is greater than the threshold value D. The threshold value A is greater than the threshold value C. The threshold value B is greater than the threshold value D.

Next, an operation of the display device 100 will be described while referring to FIG. 3. The CPU 101 starts executing the main process when the user presses a power button (not shown) to turn on the display device 100.

When the CPU 101 starts executing the main process, the CPU 101 first reads, in S5, various setting data from the hard disk drive 104 and stores the read setting data in the RAM 103. The setting data includes data of the rewriting mode stored in the hard disk drive 104. Based on the setting data stored in the RAM 103, the CPU 101 executes each subsequent process to be described later.

Next, the CPU 101 determines in S10 whether the CPU 101 has received a rewrite signal. The CPU 101 determines that the CPU 101 has received a rewrite signal when the CPU 101 has received from the input section 110 a signal indicating that any of the buttons was pressed.

When the CPU 101 determines that the rewrite signal has been received (S10: Yes), the CPU 101 executes a rewrite process in S20. Details of the rewrite process of S20 will be described later.

After executing the rewrite process of S20, the CPU 101 executes in S25 a necessary process other than the rewrite process, if any, in accordance with the rewrite signal that corresponds to the button pressed by the user and that is detected in S10 (yes in S10).

For example, now assume that while the mode selection screen is displayed in the nonvolatile display panel 105 to urge the user to select his/her desired rewriting mode from among the normal mode and power-saving mode, the user presses the determination button 110c to select his/her desired rewriting mode (yes in S10). In this case, the CPU 101 first performs an image rewriting operation in S20 to change the displayed image of the mode selection screen into an image indicating that the rewriting mode has been changed. Then, in S25, the CPU 101 updates the setting data on the rewriting mode into setting data indicative of the user's newly-selected rewriting mode and stores the same in the RAM 103.

After executing the other process in S25, the CPU 101 determines in S30 whether the user has instructed to turn off the display device 100.

If the power button is not pressed (S30: No), the CPU 101 returns to S10.

On the other hand, if the power button is pressed (S30: Yes), the CPU 101 determines that the user has instructed to turn off the display device 100. So, the CPU 101 stores the setting data stored in the RAM 103 in the hard disk drive 104, and terminates the main process. Then, the display device 100 is turned off.

Next, the rewrite process (S20 in FIG. 3) will be described in greater detail.

According to the present embodiment, even when the user presses some button 110a, 110b, or 110c to input his/her instruction to perform an image rewriting operation to change the displayed image into another image, the CPU 101 does not control the display control section 106 to execute the image rewriting operation if the battery 108 is used to supply power to the display device 100 and the voltage of the battery 108 is too low. This can prevent occurrence of a problem that due to a shortage of power in the battery, an image rewriting operation stops in the middle of the operation and therefore an incompletely-rewritten image remains displayed in the nonvolatile display panel 105.

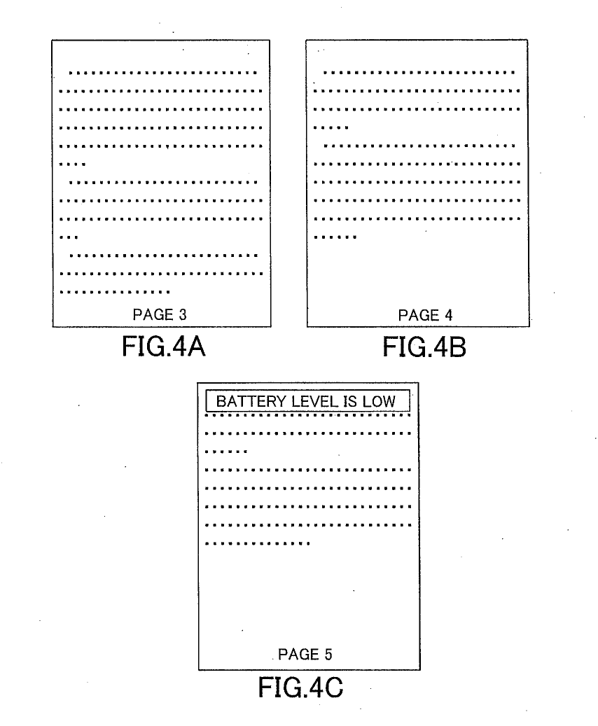

Next will be described, with referring to FIGS. 4A to 4C, how an image displayed in the nonvolatile display panel 105 is changed in succession when the user repeatedly instructs the image rewriting operation in the normal mode.

Now assume that an image of a third page in one image file is displayed on the nonvolatile display panel 105 as shown in FIG. 4A. If the user wants to change the displayed image from the third page to the fourth page, he/she presses a right direction key of the cross-shaped button 110a. In this case, the displayed image is changed from the third page (FIG. 4A) to the fourth page as shown in FIG. 4B if the voltage of the battery 108 is greater than or equal to the threshold value A.

Further assume that when the displayed image is changed from the third page to the fourth page, the power of the battery 108 is consumed and the voltage of the battery 108 falls to a value that is lower than the threshold value A but is greater than or equal to the threshold value B. In this state, if the user wants to change the displayed image further from the fourth page to the fifth page, the user again presses the right direction key of the cross-shaped button 110a. In this case, the CPU 101 generates a notification image by superimposing the predetermined message indicating that “battery level is low” on an image of the fifth page as shown in FIG. 4C, and changes the displayed image from the fourth page (FIG. 4B) to the notification image (FIG. 4C).

Further assume that when the displayed image is changed from the fourth page image to the notification image, the power of the battery 108 is consumed and the voltage of the battery 108 falls to a value lower than the threshold value B. In this state, if the user wants to change the displayed image further from the fifth page to the sixth page, the user again presses the right direction key of the cross-shaped button 110a. At this time, however, the CPU 101 does not control the display control section 106 to perform an image rewriting operation. As a result, the notification image remains displayed in the nonvolatile display panel 105. This can avoid occurrence of the problem that due to a shortage of power in the battery, an image rewriting operation stops in the middle of the operation and therefore an incompletely-changed image remains displayed in the nonvolatile display panel 105.

As described above, according to the present embodiment, the display device 100 shows the predetermined message indicating that “battery level is low,” before finally prohibiting the user from changing the displayed image to a new one. The user is preliminarily notified that the display device will not perform the image rewriting operation even if the user presses the operation button any more.

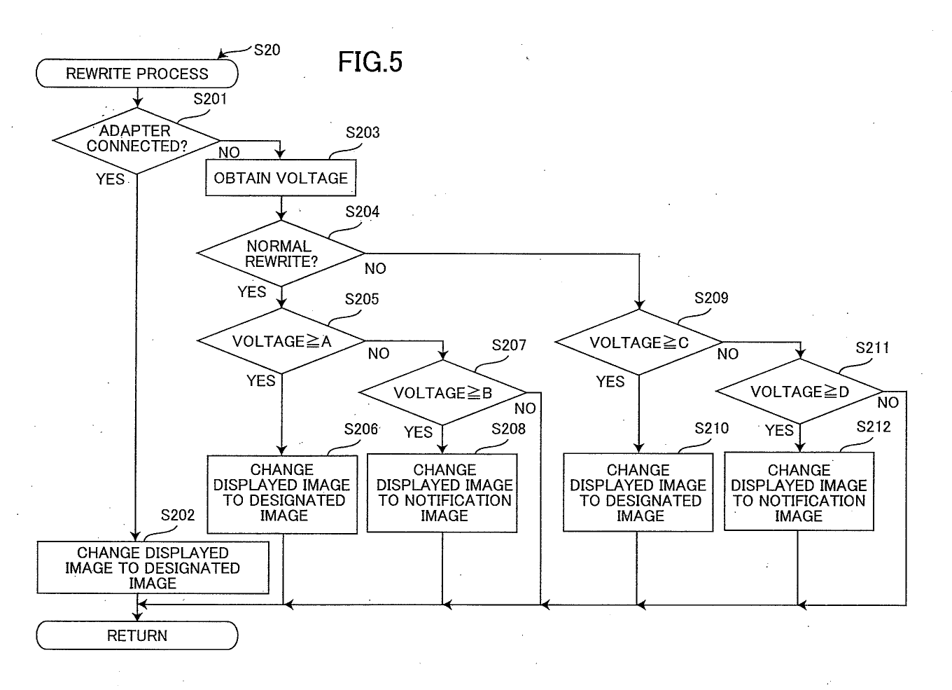

Next, the rewrite process of S20 will be described in greater detail with reference to FIG. 5.

When starting the rewrite process, the CPU 101 first determines in S201 whether electric power is supplied from the adapter 200 to each unit in the display device 100.

If the CPU 101 determines that electric power is supplied from the adapter 200 to each unit in the display device 100 (S201: Yes), the CPU 101 controls the display control section 106 in S202 to perform the image rewriting operation according to the user's pressed button and according to the currently displayed image. More specifically, the rewrite signal received by the CPU 10 in S10 is indicative of the user's pressed button. Based on the rewrite signal and the currently-displayed image, the CPU 10 specifies an image that is designated by the user to be displayed subsequently to the currently-displayed image. So, the CPU 101 controls the display control section 106 to perform the image rewriting operation to change the currently-displayed image into the user's designated image.

Assume that while one page in an image file containing a plurality of pages is displayed on the nonvolatile display panel 105, the user presses the right direction key of the cross-shaped button 110a (yes in S10 (FIG. 3)) in order to change the currently-displayed page to the next page. In this case, the CPU 101 controls the display control section 106 in S202 to perform the rewriting operation to change the currently displayed page to the next page.

Further assume that while a list of titles of a plurality of image files is displayed on the nonvolatile display panel 105, the user presses the determination button 110c while designating his/her selected image file (yes in S10 (FIG. 3)), to thereby select his/her desired image file from among the plurality of the image files. In this case, the CPU 101 controls the display control section 106 in S202 to perform the rewriting operation to change the image of the list of titles to an image of a top page of the user's selected image file.

In this way, in S202, the CPU 101 controls the display control section 106 to perform the image rewriting operation to change the currently-displayed image to the user's designated image that is determined dependently on the button pressed in S10 and on the currently-displayed image. The CPU 101 controls the display control section 106 to perform the image rewriting operation on the nonvolatile display panel 105 in the rewriting mode set in the RAM 103. After the CPU 101 controls the display control section 106 to change the currently displayed image to the user's designated image, the CPU 101 returns to the main process and advances to S25.

On the other hand, if the CPU 101 determines that electric power is not supplied from the adapter 200 (S201: No), the CPU 101 obtains in S203 the voltage of the battery 108 from the A/D converter 109, and stores the value of the obtained voltage in the RAM 103. The value of the voltage of the battery 108 indicates the amount of power remaining in the battery 108.

Next, the CPU 101 determines in S204 whether normal rewrite should be executed, by examining the rewriting mode set in the RAM 103.

If the user has selected the normal mode and therefore the setting data stored in the RAM 103 indicates the normal mode, the CPU 101 determines that the normal rewrite is to be executed (S204: Yes). So, the CPU 101 determines in S205 whether the voltage of the battery 108 obtained in S203 is greater than or equal to the threshold value A. If the obtained voltage of the battery 108 is greater than or equal to the threshold value A (S205: Yes), the CPU 101 controls the display control section 106 to perform the rewriting operation in the normal mode to change the currently displayed image to an image designated by the user in the same manner as in S202. Then, the CPU 101 returns to the main process and advances to S25.

If the CPU 101 determines that the voltage of the battery 108 obtained in S203 is lower than the threshold value A (S205: No), the CPU 101 determines in S207 whether the voltage of the battery 108 is greater than or equal to the threshold value B. If the obtained voltage of the battery 108 is greater than or equal to the threshold value B (S207: Yes), the CPU 101 controls in S208 the display control section 106 to perform the rewriting operation in the normal mode to change the currently displayed image to a notification image. It is noted that the CPU 101 generates the notification image by reading, into the RAM 103, the user's designated image and the predetermined message indicating that “battery level is low” and by superimposing the predetermined message on the user's designated image. Then, the CPU 101 returns to the main process and advances to S25.

On the other hand, if the obtained voltage of the battery 108 is lower than the threshold value B (S207: No), the CPU 101 returns to the main process, without executing the image rewriting operation, and advances to S25.

If the user has not selected the normal mode and therefore the setting data stored in the RAM 103 indicates the power-saving mode, the CPU 101 determines that the normal rewrite is not to be executed (S204: No). So, the CPU 101 determines in S209 whether the voltage of the battery 108 obtained in S203 is greater than or equal to the threshold value C. If the obtained voltage of the battery 108 is greater than or equal to the threshold value C (S209: Yes), the CPU 101 controls in S210 the display control section 106 to perform the image rewriting operation in the power-saving mode to change the currently displayed image to the image designated by the user in the same manner as in S202. Then, the CPU 101 returns to the main process and advances to S25.

On the other hand, if the voltage of the battery 108 obtained in S203 is lower than the threshold value C (S209: No), the CPU 101 determines in S211 whether the voltage of the battery 108 is greater than or equal to the threshold value D. If the voltage of the battery 108 is greater than or equal to the threshold value D (S211: Yes), the CPU 101 controls in S212 the display control section 106 to perform the image rewriting operation in the power-saving mode to change the currently displayed image to a notification image in the same manner as in S208. Then, the CPU 101 returns to the main process and advances to S25.

On the other hand, if the voltage of the battery 108 is lower than the threshold value D (S211: No), the CPU 101 returns to the main process without performing the image rewriting operation and advances to S25.

As described above, in the case where the voltage indicating the amount of power remaining in the battery 108 is lower than the threshold value for the user's selected rewriting mode (the threshold value B for the normal mode or the threshold value D for the power-saving mode), even if the user presses any of the buttons 110a, 110b, and 110c to input his/her instruction to rewrite the displayed image, the CPU 101 does not rewrite the displayed image. This can avoid the occurrence of a problem that due to a shortage of the power in the battery, the image rewriting operation stops in the middle thereof and an incompletely-changed image remains displayed in the nonvolatile display panel 105.

Especially, the CPU 101 changes the threshold values, with which the CPU 101 compares the voltage of the battery 108, between the values A and B and the values C and D, dependently on the rewriting mode (normal or power-saving) in which the nonvolatile display section 120 will perform the image rewriting operation. The occurrence of the problem can be avoided in each rewriting mode.

Additionally, if electric power is supplied from the adapter 200 to the display device 100 (S201: Yes), the CPU 101 performs in S202 the image rewriting operation regardless of the voltage of the battery 108. This is because when electric power is supplied from the adapter 200, the image rewriting operation will not stop in the middle of the process due to a shortage of the power in the battery 108.

<Modification>

In the embodiment described above, the display device 100 displays the notification image, before prohibiting the image rewriting operation. However, the display device 100 may be modified not to display the notification image. In addition, the display device 100 may be modified not to execute the image rewriting operation in the power-saving mode. In other words, the display device 100 may be modified to execute the image rewriting operation in the normal mode, only.

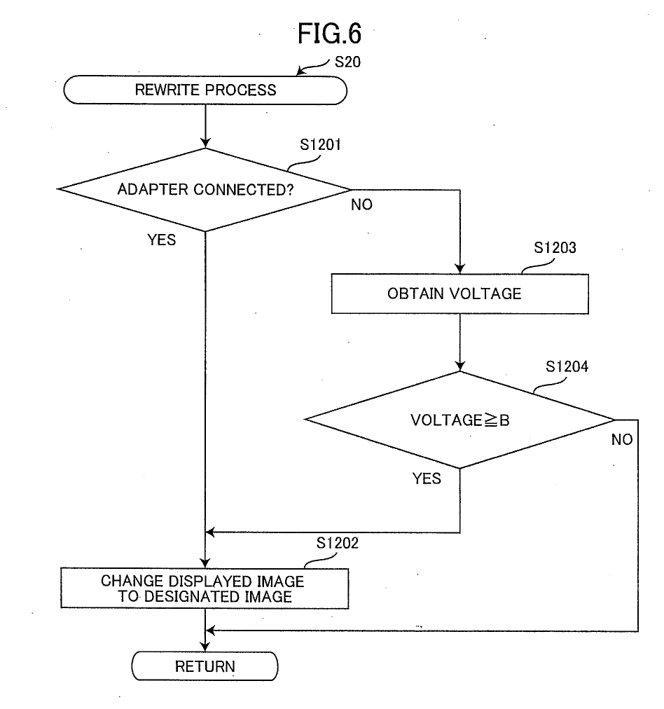

According to this modification, the rewrite process of S20 is modified as shown in FIG. 6.

When starting the rewrite process of S20, the CPU 101 determines in S1201 whether electric power is supplied from the adapter 200 to each unit in the display device 100.

If the CPU 101 determines that electric power is supplied from the adapter 200 (S1201: Yes), the CPU 101 controls in S1202 the display control section 106 to perform the image rewriting operation to change the currently-displayed image to the user's designated image in the same manner as in S202 in the embodiment (FIG. 5). Then, the CPU 101 returns to the main process and advances to S25.

On the other hand, if the CPU 101 determines that electric power is not supplied from the adapter 200 (S1201: No), the CPU 101 obtains in S1203 the voltage of the battery 108 from the A/D converter 109 and stores data of the obtained voltage in the RAM 103.

Next, the CPU 101 determines in S1204 whether the voltage of the battery 108 obtained in S1203 is greater than or equal to the threshold value B. If the obtained voltage of the battery 108 is greater than or equal to the threshold value B (S1204: Yes), the CPU 101 executes the image rewriting operation in S1202 in the same manner as described above. Then, the CPU 101 returns to the main process and advances to S25.

On the other hand, if the obtained voltage of the battery 108 is lower than the threshold value B (S1204: No), the CPU 101 returns to the main process without executing the image rewriting operation and advances to S25.

While the invention has been described in detail with reference to the embodiment and modification thereof, it would be apparent to those skilled in the art that various changes and modifications may be made therein without departing from the spirit of the invention.

In the embodiment, the battery 108 is a rechargeable battery. However, the battery 108 may be a primary (non-rechargeable) battery.

The adapter 200 may not be provided in the display device 100. In such a case, the processes of S201 and 5202 may be omitted from the rewrite process of FIG. 5, and the process of S1201 may be omitted from the rewrite process of FIG. 6.

In the above-described embodiment, the amount of power remaining in the battery 108 is determined by measuring the voltage of the battery 108. However, the amount of power remaining in the battery 108 may be determined by calculating the total amount of the already-consumed power based on the driving conditions of the respective units in the display device 100 and based on the amounts of electric power consumed by the respective units that are driven under these driving conditions. For example, the amount of power remaining in the battery 108 may be determined based on the number of times that the image rewriting operation has been executed since the battery 108 was fully charged and based on the amount of electric power that is consumed by each image rewriting operation.

In the above-described embodiment, in S208 and in S212, the notification image is generated by superimposing the predetermined message on an image designated by the user. However, the notification image may be generated to show the predetermined message only. That is, the notification image may be generated based on the predetermined message but not based on the user's designated image.

Or, the notification image may be a composite image that is generated by combining the predetermined message and the user's designated image such that the user's designated image occupies a part of the display region of the nonvolatile display panel 105 and the predetermined message occupies a remaining part of the display region of the nonvolatile display panel 105. In such a composite image, no part of the predetermined message is superimposed on the user's designated image.

In the embodiment, the notification image includes the predetermined message saying “battery level is low”. However, the notification image may include other various messages, such as a message saying “not rewritable”. Or, the notification image may include an icon or the like having a predetermined shape in place of the predetermined message.

In the embodiment described above, the threshold value A is equal to the value of the voltage of the battery 108 that is necessary for performing an image rewriting operation two times in the normal mode. The threshold value B is equal to the value of the voltage of the battery 108 that is necessary for performing an image rewriting operation one time in the normal mode. The threshold value C is equal to the value of the voltage of the battery 108 that is necessary for performing an image rewriting operation two times in the power-saving mode. The threshold value D is equal to the value of the voltage of the battery 108 that is necessary for performing an image rewriting operation one time in the power-saving mode. However, the threshold values A-D may not be limited to the above-described values. The threshold value A may be equal to such a value of the voltage that is necessary for performing an image rewriting operation more than two times in the normal mode. The threshold value B may be equal to such a value of the voltage that is necessary for performing an image rewriting operation more than one time in the normal mode. The threshold value C may be equal to such a value of the voltage that is necessary for performing an image rewriting operation more than two times in the power-saving mode. The threshold value D may be equal to such a value of the voltage that is necessary for performing an image rewriting operation more than one time in the power-saving mode. Still in this case, the threshold value A is preferably greater than the threshold value B. The threshold value C is preferably greater than the threshold value D. The threshold value A is preferably greater than the threshold value C. The threshold value B is preferably greater than the threshold value D. To summarize, it is preferable: that the threshold value A is equal to a value of voltage necessary for performing an image rewriting operation two or more times in the normal mode; that the threshold value B is equal to a value of voltage necessary for performing an image rewriting operation one or more time in the normal mode; that the threshold value C is equal to a value of voltage necessary for performing an image rewriting operation two or more times in the power-saving mode; that the threshold value D is equal to a value of voltage necessary for performing an image rewriting operation one or more time in the power-saving mode; that the threshold value A is greater than the threshold value B; that the threshold value C is greater than the threshold value D; that the threshold value A is greater than the threshold value C; and that the threshold value B is greater than the threshold value D.

The rewriting mode (normal mode or power-saving mode) may be set on an image-by-image basis. In such a case, either the normal mode or power-saving mode is previously set for each image. The threshold values are selected from among the threshold values A and B and the threshold values C and D, depending on which of the modes is set to the user's designated image. In other words, in S204, the CPU 101 judges whether the normal rewrite should be executed for an image designated by the user to be displayed next, by examining which of the normal mode and the power-saving mode is set for the subject image.

In the above-described embodiment, the power-saving mode is different from the normal mode in the length of the duration for applying the drive voltage. However, the power-saving mode may be different from the normal mode in the amount of the drive voltage. That is, the drive voltage in the power-saving mode may be lower than that in the normal mode. Still in this modification, power consumption can be lowered in the power-saving mode than the normal mode.

Or, the power-saving mode may be different from the normal mode in the manner of using the display region. For example, in the normal mode, the image rewriting operation is executed onto the entire portion of the display region of the nonvolatile display panel 105, similarly in the embodiment. Accordingly, the entire part of the currently-displayed image is changed into a new image. However, in the power-saving mode, the image rewriting operation is executed only onto a half portion of the display region so that only a half portion of the currently-displayed image is changed into a corresponding half portion of the new image, but the other remaining half of the currently-displayed image remains displayed unchanged. Still in this modification, power consumption can be lowered in the power-saving mode than in the normal mode.

The image rewriting mode can be selected from among more than two different modes.

Before performing an image rewriting operation, the CPU 101 may calculate the amount of electric power that is to be actually consumed if the image rewriting operation is performed. Based on the calculated amount of electric power to be actually consumed, the CPU 101 changes the values of the threshold values A-D, with which the CPU 101 will compare the voltage value of the battery 108 to determine whether to perform an image rewriting operation. Electric power consumption varies depending on: the characteristics of the nonvolatile display section 120; and an image to be displayed. Now assume that the nonvolatile display panel 105 is of such an electrophoretic type that can display four levels of gradation: white, light grey, dark grey, and black. This type of nonvolatile display panel 105 consumes less electric power when displaying a black-and-white image constituted of black pixels and white pixels only, compared to when displaying a four gradation image constituted of four kinds of pixels including light grey pixels, dark grey pixels, black pixels, and white pixels. This is because a driving voltage has to be applied to a pixel for a longer period of time when controlling the pixel to show light grey or dark grey, compared to when controlling the pixel to show white or black. For such a display panel, it would be effective to calculate, prior to performing an image rewriting operation, the amount of electric power that the display device will actually consume when performing the image rewriting operation, and to change the threshold values A-D depending on the calculated result.

Further, the display device 100 may be additionally provided with a temperature sensor for measuring a temperature of the battery 108 or a temperature around the display device 100. The values of the threshold values A-D, with which the CPU 101 compares the voltage of the battery 108, are changed depending on the temperature measured by the temperature sensor. This is because the amount of electric power that is required to perform an image rewriting operation varies depending on the temperature around the display device 100. The value of the voltage, which indicates the amount of power remaining in the battery 108, varies also depending on the temperature of the battery 108.

The nonvolatile display panel 105 is not limited to the electrophoretic type. The nonvolatile display panel 105 may be of a cholesteric liquid crystal type, for example.

In the embodiment, the battery 108 is detachably mounted in the battery holding section 112. However, the battery 108 may not be detached from the battery holding section 112.

What is claimed is:

1. A display device comprising:
a nonvolatile display unit that is configured so as to be capable of displaying an image and maintaining the displayed image even when the nonvolatile display unit is supplied with no electric power;
a battery holding unit that is configured so as to be holding a battery, the battery held in the battery holding unit being capable of supplying electric power to the nonvolatile display unit;
an input unit that is configured so as to be capable of receiving an image rewrite instruction to perform an image rewriting operation to change an image currently displayed in the nonvolatile display unit;
a determining unit that is configured so as to be capable of determining an amount of power that remains in the battery held in the battery holding unit; and
a rewrite control unit that, in response to the image rewrite instruction, controls the nonvolatile display unit to perform an image rewriting operation to change the currently-displayed image if the amount of power that remains in the battery is greater than or equal to a threshold value and controls the nonvolatile display unit not to perform the image rewriting operation if the amount of power that remains in the battery is smaller than the threshold value.

2. The display device as claimed in claim 1, wherein the determining unit includes an obtaining unit that is configured so as to be capable of obtaining a value indicative of the amount of power remaining in the battery held in the battery holding unit; and
wherein the rewrite control unit controls, in response to the image rewrite instruction, the obtaining unit to obtain the value and compares the value with the threshold value.

3. The display device as claimed in claim 1, wherein the battery is detachably mounted in the battery holding unit.

4. The display device as claimed in claim 1, further comprising a threshold value changing unit that changes the threshold value in accordance with a predetermined condition, and
wherein the rewrite control unit includes a comparing unit that compares the amount of power remaining in the battery with the threshold value that is changed by the threshold value changing unit.

5. The display device as claimed in claim 4, further comprising a rewrite mode setting unit that sets a rewrite mode, in which the rewrite control unit controls the nonvolatile display unit to perform the image rewriting operation, and
wherein the threshold value changing unit changes the threshold value in accordance with the rewrite mode set by the rewrite mode setting unit.

6. The display device as claimed in claim 1,
wherein the rewrite control unit controls the nonvolatile display unit to perform the image rewriting operation to change the currently-displayed image into another image if the amount of power that remains in the battery is greater than or equal to a first threshold value, the another image being specified based on the image rewrite instruction,
wherein the rewrite control unit controls the nonvolatile display unit to perform another image rewriting operation to change the currently-displayed image into a notification image if the amount of power that remains in the battery is smaller than the first threshold value and greater than or equal to a second threshold value, the second threshold value being lower than the first threshold value, the notification image including a predetermined message, and
wherein the rewrite control unit controls the nonvolatile display unit to perform no image rewriting operation if the amount of power that remains in the battery is smaller than the second threshold value.

7. The display device as claimed in claim 6, further comprising:
a storage unit that stores the predetermined message and the another image, and
wherein the rewrite control unit includes a notification image generating unit that combines the predetermined message with the another image to generate the notification image when the amount of power that remains in the battery is smaller than the first threshold value and greater than or equal to the second threshold value.

8. A method of controlling a nonvolatile display unit by using electric power supplied from a battery, the nonvolatile display unit being configured so as to be capable of displaying an image and maintaining the displayed image even when the nonvolatile display unit is supplied with no electric power, the method comprising:
receiving an image rewrite instruction to perform an image rewriting operation to change an image currently displayed in the nonvolatile display unit;
determining an amount of power that remains in the battery; and
controlling, in response to the image rewrite instruction, the nonvolatile display unit to perform an image rewriting operation to change the currently-displayed image if the amount of power that remains in the battery is greater than or equal to a threshold value and controlling the nonvolatile display unit not to perform the image rewriting operation if the amount of power that remains in the battery is smaller than the threshold value.

9. The method as claimed in claim 8,
wherein the determining includes: obtaining a value indicative of the amount of power remaining in the battery, in response to the image rewrite instruction; and
wherein the controlling includes: comparing the obtained value with the threshold value.

10. The method as claimed in claim 8, further comprising: changing the threshold value in accordance with a predetermined condition,
wherein the controlling includes: comparing the amount of power that remains in the battery with the changed threshold value.

11. The method as claimed in claim 10, further comprising: setting a rewrite mode, in which the nonvolatile display unit is to perform the image rewriting operation, the threshold value being changed in accordance with the set rewrite mode.

12. The method as claimed in claim 8,
wherein the controlling controls the nonvolatile display unit to perform the image rewriting operation to change the currently-displayed image into another image if the amount of power that remains in the battery is greater than or equal to a first threshold value, the another image being specified based on the image rewrite instruction,
wherein the controlling controls the nonvolatile display unit to perform another image rewriting operation to change the currently-displayed image into a notification image if the amount of power that remains in the battery is smaller than the first threshold value and greater than or equal to a second threshold value, the second threshold value being lower than the first threshold value, the notification image including a predetermined message, and
wherein the controlling controls the nonvolatile display unit to perform no image rewriting operation if the amount of power that remains in the battery is smaller than the second threshold value.

13. The method as claimed in claim 12, wherein the notification image is generated by combining the message with the another image.

14. A computer readable storage medium storing a set of program instructions for controlling a nonvolatile display unit by using electric power supplied from a battery, the nonvolatile display unit being configured so as to be capable of displaying an image and maintaining the displayed image even when the nonvolatile display unit is supplied with no electric power, the instructions comprising:
receiving an image rewrite instruction to perform an image rewriting operation to change an image currently displayed in the nonvolatile display unit;
determining an amount of power that remains in the battery; and
controlling, in response to the image rewriting instruction, the nonvolatile display unit to perform an image rewriting operation to change the currently-displayed image if the amount of power that remains in the battery is greater than or equal to a threshold value and controlling the nonvolatile display unit not to perform the image rewriting operation if the amount of power that remains in the battery is smaller than the threshold value.
